(19) United States
(12) Patent Application Publication
(10) Pub. No.: US 2016/0027017 A1
(43) Pub. Date: Jan. 28, 2016

(54) METHOD AND SYSTEM FOR USING DYNAMIC CVV IN QR CODE PAYMENTS

(71) Applicant: Mahesh Chitragar, Bangalore (IN)

(72) Inventor: Mahesh Chitragar, Bangalore (IN)

(73) Assignee: CA, INC., Islandia, NY (US)

(21) Appl. No.: 14/337,961

(22) Filed: Jul. 22, 2014

(51) Int. Cl. G06Q 20/40; G06Q 20/32; G06Q 20/20; G06Q 20/38

(52) U.S. Cl. CPC G06Q 20/4018; G06Q 20/3829; G06Q 20/4014; G06Q 20/3274; G06Q 20/202; G06Q 2220/00

(57) ABSTRACT

A method for using dynamic CVV in QR code payments is described. The method comprises generating a random number, via a payment module, on a mobile device for a mobile transaction, authenticating user account information, and decrypting encrypted user data when the user account information is authenticated. The method also comprises retrieving a user account unique key, determining a counter number via an application transaction counter, and generating a dynamic verification code, via the payment module, based on the generated random number, the user data, the counter number, and the user account unique key. The method further comprises generating track data, the track data comprising the user data, the random number, and the dynamic verification code, generating a two-dimensional matrix barcode from the track data, and displaying, via the payment module, the generated matrix barcode to a sales terminal for the mobile transaction.

### BACKGROUND

The disclosure relates generally to providing secure credit card payments, and more specifically to a method and system for using dynamic CVV in QR code payments.

### SUMMARY

According to one embodiment of the disclosure, a method comprises generating a random number, via a payment module, on a mobile device for a mobile transaction, authenticating user account information, and decrypting encrypted user data when the user account information is authenticated. The method also comprises retrieving a user account unique key, determining a counter number via an application transaction counter, and generating a dynamic verification code, via the payment module, based on the generated random number, the user data, the counter number, and the user account unique key. The method further comprises generating track data, the track data comprising the user data, the random number, and the dynamic verification code, generating a two-dimensional matrix barcode from the track data, and displaying, via the payment module, the generated matrix barcode to a sales terminal for the mobile transaction.

Other features and advantages of the present disclosure are apparent to persons of ordinary skill in the art in view of the following detailed description of the disclosure and the accompanying drawings.

### BRIEF DESCRIPTION OF THE DRAWINGS

For a more complete understanding of the configurations of the present disclosure, needs satisfied thereby, and the features and advantages thereof, reference now is made to the following description taken in connection with the accompanying drawings.

FIG. 1 illustrates a block diagram of a network for a user to access an application rejuvenation module, in accordance with a particular embodiment of the present disclosure.

FIG. 2 illustrates a block diagram of a system for presenting the application rejuvenation module, in accordance with a particular embodiment of the present disclosure.

FIG. 3 illustrates a flow chart of a method for rejuvenating a legacy code via the application rejuvenation module, in accordance with a particular embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

While certain example systems and methods disclosed herein may be described with reference to mainframes in cloud computing, systems and methods disclosed herein may be related to architecture and information technology (“IT”) service and asset management in cloud computing, as well as usability and user experience in middleware and common services. Systems and methods disclosed herein may be applicable to a broad range of applications that monitor various parameters associated with various disciplines, such as, for example, IT systems and other activities of importance to the user.

In the last fifty years, payment cards, and in particular, credit cards, have been an immensely popular method of payment for goods and services. This is due in large part on the fact that credit cards provide a variety of advantages for both the user and the merchant. For example, credit cards often have magnetic strips that can contain a variety of information such as a card holder's identify and account information. In addition, for example, credit cards offer users and merchants the convenience of not having to carry or maintain large amounts of cash, deferring payment of a credit card balance (for the user), and the ability to purchase goods and/or services online securely using encrypted information.

More recently, in view of the recent explosion of mobile phone technology, the ability to use mobile phones to make contactless payments for goods and services has been an area of particular interest. There are basically two ways of conducting contactless mobile payments today that do not involve any cards or the swiping of such cards: Near Field Communications (“NFC”) based payments and Quick Response (“QR”) based payments. In NFC based transactions, a NFC-enabled device is capable of establishing wireless communication with another NFC-enable device by being brought into proximity with, without being touched to, the other device (e.g., the ability to tap a mobile device to a checkout terminal and the transaction is complete). In QR based transactions, a two-dimensional barcode, or matrix barcode, contains information about a transaction that can be read (i.e., processed) by a QR-code reading machine. For example, a QR code can be generated by a merchant, and a customer can use a mobile device and scan the QR code to complete the transaction; alternatively, the customer can generate a QR code, and the checkout terminal can scan the QR code to complete the transaction.

With regard to NFC-enabled devices being used in contactless payment methods, NFC-based payments can provide a more secure payment method compared with QR-based payments because NFC-based payments works on Europay, Mastercard and Visa (“EMV”) technologies, which is a global standard that defines a suite of protocols employing strong cryptograph for the interoperation of EMV-enabled cards with EMV-capable point of sale (“POS”) terminals and automated teller machines (“AMTs”) for authenticating transactions. However, NFC based payments often involve multiple parties and require more expensive mobile handsets that are be NFC-compatible.

On the other hand, QR-based payments, while easier to implement, often result in more transactions charges due to the “Card Not Present” charges because there is no card authentication. Typically, when a payment transaction is conducted with a credit card present during the transaction, the credit card company (e.g., Visa, Mastercard, American Express, etc.) is able to confirm the identity of a user and charges a fee that amounts to a certain percentage of the transaction (e.g., 2%). However, when a payment transaction is conducted in which a credit card is not present during the transaction, for example, in online transactions, much higher Card Not Present charges result (e.g., 2.3-2.5%) because of the higher risks of fraud associated with the inability to confirm the identity of the user and the authenticity of the credit card during the transaction.

In addition, other problems associated with QR code based payments include that network connectivity is required for the mobile device (i.e., the mobile device must be able to connect to the internet), and QR code based payments do not provide the level of security that NFC provides. Specifically, NFC based payments often use a method of user authentication using a dynamic card validation value (“CVV”), which is a code electronically generated for use with NFC based payments. When a typical credit card is swiped at a POS, or used for online payments of goods and/or services (i.e., there is no POS terminal present), a user provide the card number, expiration date, and sometimes a billing address to the POS terminal. In addition, in online payments, the user may be also asked to input a 3-number (or 4-number) validation code printed on the card itself, which is called a CVV (often CVV1 or CVV2). The CVV simplifies the process of authenticating the user information when received by the issuing bank. However, because the CVV numbers are printed on the card itself, they are constant for the life of the card, and therefore prone to security issues. In contrast, a dynamically generated CVV provides for a newly generated, different CVV value for each transaction, result in a more secure payment method. Moreover, for security purposes, the dynamic CVV is only valid for a single mobile transaction, resulting in more secure transactions.

When the situation where the mobile device is used for making payments, either through NFC or QR based payments, all card data (e.g., card number, expiration data, billing address, and other relevant data) is encrypted and stored on the mobile device. A key used to encrypt the card data may be either camouflaged using CA ArcotID technology (found, for example, on www.ca.com), a key derived from a pin known to the user, or stored in a secure element of the mobile device. In addition, an account unique key (“AUKey”) used to generated a dynamic CVV is stored either in a secure element of the mobile device, or camouflaged using CA ArcotID technology. In particular, a dynamic CVV is generated based on the AUkey, an unpredictable number, a card number, and an application transaction counter (“ATC”). The unpredictable number may be provided by the POS, by the issuer (e.g., the issuer of the credit card), or prefetched in a batch. For example, when the unpredictable number is provided by the issuer, the issuer can verify the dynamic CVV against the unpredictable number (which was sent by the issuer itself). The ATC is a counter maintained by a chip card application that provides a sequential reference to each transaction for fraud monitoring purposes. For example, a duplicate ATC, a decrease in ATC, or a large jump in ATC values may indicate data copying or other fraudulent activities on the card. In addition, for security purposes, the counter number is incremented by one, via the ATC, after each transaction, and the incremented counter number is stored in a memory (e.g., a memory of the mobile device).

In a typical NFC based payment, the mobile device is capable of connecting to the network (e.g., via the internet) to obtain the unpredictable number from the POS in order to generate a dynamic CVV to complete a transaction. However, in QR based payment methods which typically do not have access to the network, the unpredictable number cannot “travel” from the POS to the mobile device.

The teachings of the present disclosure may provide a method and system for providing a QR code based payment transaction that is capable of generating a dynamic CVV without having to connect to a network via the internet. In particular, the teachings of the present disclosure provide a method and system that allows QR code-based mobile payments to be as secure as EMV payments on basic smart phone with a camera capability without the need for internet connectivity. Moreover, because the teachings of the present disclosure can provide a method and system capable of authenticating a user, no transactions charges due to the “Card Not Present” charges are charged as a result of the payment transaction.

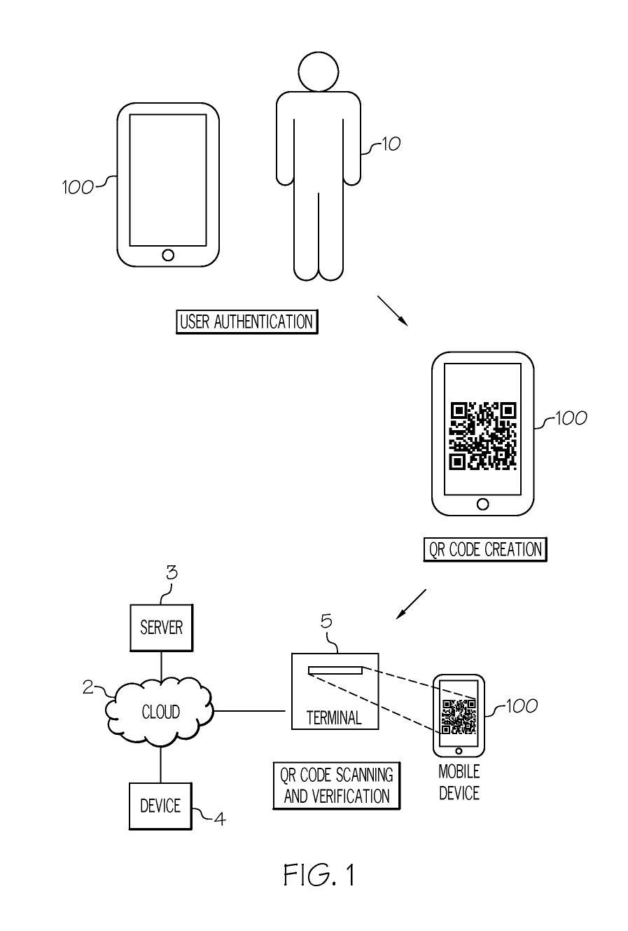

Referring now to FIG. 1, a block diagram of a network for a user to access an application rejuvenation module is shown. In a user authentication stage (discussed below), a user 10 owns a mobile device 100. In a QR code creation stage (discussed below), mobile device 100 displays a QR code 20. In a QR code scanning and verification stage (discussed below), a network 1 allows for communication between a terminal 5 (e.g., a POS terminal which may contain a payment verification module), server 3, device 4, and mobile device 100 (e.g., which may contain a QR payment module). Network 1 may comprise one or more clouds 2, which may be public clouds, private clouds, or community clouds. Each cloud 2 may permit the exchange of information and services among entities that are connected to such clouds 2. In certain configurations, cloud 2 may be a wide area network, such as the Internet. In some configurations, cloud 2 may be a local area network, such as an intranet. Cloud 2 may facilitate wired or wireless communications of information among entities that are connected to cloud 2.

Network 1 may comprise one or more servers 3 and/or other devices 4 operated by service providers (e.g., credit card companies, third party card information verification entities, etc.). Service providers and users may provide information to each other utilizing the one or more servers 3, which connect to the one or more devices 4 via cloud 2. Servers 3 may comprise, for example, one or more of general purpose computing devices, specialized computing devices, mainframe devices, wired devices, wireless devices, monitoring devices, infrastructure devices, and other devices configured to provide information to service providers and users. Devices 4 may comprise, for example, one or more of general purpose computing devices, specialized computing devices, mobile devices, wired devices, wireless devices, passive devices, routers, switches, mainframe devices, monitoring devices, infrastructure devices, and other devices utilized by service providers and users. Example items may include network 1, cloud 2, servers 3, and devices 4.

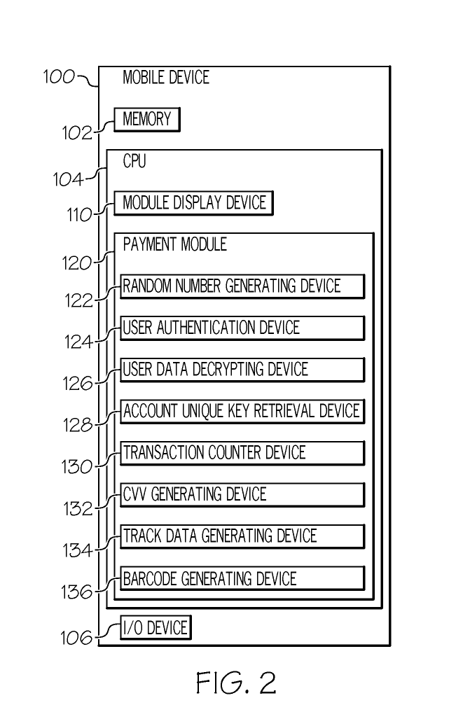

Referring now to FIG. 2, mobile device 100, which may provide a QR payment module, is now described. Mobile device 100 may connect to one or more networks 1. Mobile device 100 may comprise a memory 102, a central processing unit (“CPU”) 104, and an input and output (“I/O”) device 106.

Memory 102 may store computer-readable instructions that may instruct mobile device 100 to perform certain processes. As discussed above, memory 102 may comprise, for example, RAM, ROM, EPROM, Flash memory, or any suitable combination thereof. In particular, when executed by CPU 104, the computer-readable instructions stored in memory 102 may instruct CPU 104 to operate as one or more devices.

CPU 104 may operate as one or more of module display device 110 and payment module 120. Payment module 120 may comprise a random number generating device 122, a user authentication device 124, a user data decrypting device 126, an account unique key retrieval device 128, a transaction counter device 130, a CVV generating device 132, a track data generating device 134, and a barcode generating device 136.

I/O device 106 may receive one or more of data from networks 1, data from other devices connected to mobile device 100, and input from a user and provide such information to CPU 104. I/O device 106 may transmit data to networks 1, may transmit data to other devices connected to mobile device 100, and may transmit information to a user (e.g., display the information via a display device). Further, I/O device 106 may implement one or more of wireless and wired communication between mobile device 100 and other devices.

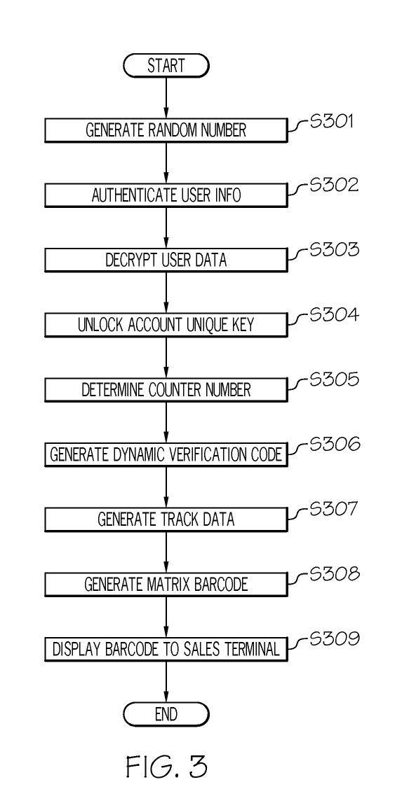

Referring now to FIG. 3, processes performed by payment module 120 of mobile device 100 are now described. In step S301, payment module 120, operating as random number generating device 122, generates a secure random number (e.g., an unpredictable number). Then, in step S302, payment module 120, operating as user authentication device 124, may authenticate user information. For example, the payment mobule 120 may require the user to input a password or authentication code, for example, via I/O device 106, to authenticate the identity of the user.

In step S303, payment module 120, operating as user data decrypting device 126, may decrypt the card data (e.g., information relating to the user's account, including the card number, expiration date, and billing address). As discussed above, all card data is encrypted and stored on the mobile device. A key used to encrypt the card data may be either camouflaged using CA ArcotID technology, a key derived from a pin known to the user, or stored in a secure element of the mobile device (e.g., memory 102).

Then, in step S304, payment module 120, operating as account unique key retrieval device 128, unlocked an AUKey. As discussed above, the AUKey is stored either in a secure element of the mobile device (e.g., memory 102), or camouflaged using CA ArcotID technology. In step S305, payment module 120, operating as a transaction counter device 130, determines a counter number (e.g., an ATC). As discussed above, the ATC is a counter maintained by a chip card application that provides a sequential reference to each transaction for fraud monitoring purposes.

In step S306, payment module 120, operating as a CVV generating device 132, generates a dynamic verification code (i.e., a dynamic CVV) using the determined random number, user data, AUKey, and ATC. As discussed above, this dynamic CVV is newly generated for each new transaction in order to obtain a more secure payment method. Then, in step S307, payment module 120, operating as a track data generating device 134, generates track data. For example, the track data combines all the information necessary for the mobile payment transaction (e.g., the card number, the expiry data, the name of the user, the dynamic CVV, and the random number).

Then, in step S308, payment module 120, operating as a barcode generating device 136, generates a matrix barcode (i.e., a QR code) that contains all the information in the track data. In step S309, module display device 110 takes the generated QR code and displays the QR code to the sales terminal (i.e., the POS terminal). The POS terminal may scan and read the QR code, construct the contactless authorization message, and forward the message to the vendor (e.g., an issuing bank that issued the credit card whose information in contained in the QR code) for processing. After the generated QR code is displayed to the POS terminal, the process may terminate.

The flowchart and block diagrams in FIGS. 1-3 illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
generating a random number, via a payment module, on a mobile device for a mobile transaction;
authenticating user account information;
decrypting encrypted user data when the user account information is authenticated;
retrieving a user account unique key;
determining a counter number via an application transaction counter;
generating a dynamic verification code, via the payment module, based on the generated random number, the user data, the counter number, and the user account unique key;
generating track data, the track data comprising the user data, the random number, and the dynamic verification code;
generating a two-dimensional matrix barcode from the track data; and
displaying, via the payment module, the generated matrix barcode to a sales terminal for the mobile transaction.

2. The method of claim 1, wherein the encrypted user data is encrypted by:
using cryptographic camouflage,
using a secure key derived from a code known to the user, or
storing the user data in a secure element of the mobile device.

3. The method of claim 1, wherein the user data comprises a credit card number and a credit card expiration date.

4. The method of claim 1, wherein the counter number is incremented by one, via the application transaction counter, after each mobile transaction, and
wherein the incremented counter number is stored in a memory.

5. The method of claim 1, wherein a unique dynamic verification code is generated for each mobile transaction.

6. The method of claim 5, wherein the unique dynamic verification code is only valid for a single mobile transaction.

7. The method of claim 1, wherein the two dimensional matrix barcode comprises a Quick Response (QR) code, and
wherein the QR code contains information on the user data, the random number, and the dynamic verification code of the track data.

8. A system, comprising:
a random number generating device configured to generate a random number, via a payment module, on a mobile device for a mobile transaction;
a user authentication device configured to authenticate user account information;
a user data decrypting device configured to decrypt encrypted user data when the user account information is authenticated;
an account unique key retrieval device configured to retrieve a user account unique key;
a transaction counter device configured to determine a counter number via an application transaction counter;
a dynamic verification code generating device configured to generate a dynamic verification code, via the payment module, based on the generated random number, the user data, the counter number, and the user account unique key;
a track data generating device configured to generate track data, the track data comprising the user data, the random number, and the dynamic verification code;
a barcode generating device configured to generate a two-dimensional matrix barcode from the track data; and
a display device configured to display, via the payment module, the generated matrix barcode to a sales terminal for the mobile transaction.

9. The system of claim 8, wherein the encrypted user data is encrypted by:
using cryptographic camouflage;
using a secure key derived from a code known to the user, or
storing the user data in a secure element of the mobile device.

10. The system of claim 8, wherein the user data comprises a credit card number and a credit card expiration date.

11. The system of claim 8, wherein the counter number is incremented by one, via the application transaction counter, after each mobile transaction, and
wherein the incremented counter number is stored in a memory.

12. The system of claim 8, wherein a unique dynamic verification code is generated for each mobile transaction.

13. The system of claim 12, wherein the unique dynamic verification code is only valid for a single mobile transaction.

14. The system of claim 13, wherein the two dimensional matrix barcode comprises a Quick Response (QR) code, and
wherein the QR code contains information on the user data, the random number, and the dynamic verification code of the track data.

15. A computer program product comprising:
a computer-readable storage medium having computer-readable program code embodied therewith, the computer-readable program code comprising:
computer readable program code configured to generate a random number, via a payment module, on a mobile device for a mobile transaction;
computer readable program code configured to authenticate user account information;
computer readable program code configured to define an error-handling mechanism based on an error-handling mechanism of the non-web-based application;
computer readable program code configured to retrieve a user account unique key;
computer readable program code configured to determine a counter number via an application transaction counter;
computer readable program code configured to generate a dynamic verification code, via the payment module, based on the generated random number, the user data, the counter number, and the user account unique key;
computer readable program code configured to generate track data, the track data comprising the user data, the random number, and the dynamic verification code;
computer readable program code configured to generate a two-dimensional matrix barcode from the track data; and
computer readable program code configured to display, via the payment module, the generated matrix barcode to a sales terminal for the mobile transaction.
